(19) United States
(12) Patent Application Publication
(10) Pub. No.: US 2016/0335493 A1
(43) Pub. Date: Nov. 17, 2016

(54) METHOD, APPARATUS, AND NON-TRANSITORY COMPUTER-READABLE STORAGE MEDIUM FOR MATCHING TEXT TO IMAGES

(71) Applicants: Jichuan ZHENG, Beijing (CN); Shanshan JIANG, Beijing (CN); Qian LI, Beijing (CN)

(72) Inventors: Jichuan ZHENG, Beijing (CN); Shanshan JIANG, Beijing (CN); Qian LI, Beijing (CN)

(21) Appl. No.: 15/154,490

(22) Filed: May 13, 2016

(30) Foreign Application Priority Data
May 15, 2015 (CN) 2015025647

(51) Int. Cl. G06K 9/00

(52) U.S. Cl. CPC G06K 9/00456; G06K 9/00463; G06K 2209/27

(57) ABSTRACT

A method and apparatus are provided for acquiring a plurality of images and corresponding text comments that includes a plurality of segments; retrieving, based on a pre-established key-word library, a key word of each segment; and matching a segment, based on the key word retrieved from the segment, to a corresponding image selected from the plurality of images.

### CROSS-REFERENCE TO RELATED APPLICATIONS

The present application is based on and claims the benefit of priority under 35 U.S.C. §119 to Chinese Priority Application No. 2015025647 tiled on May 15, 2015, the entire contents of which are hereby incorporated by reference.

### BACKGROUND

1. Field of the Invention

The present invention relates to a method and apparatus of matching text to images, and specifically, relates to a method, an apparatus, and a non-transitory computer-readable storage medium for matching text to a plurality of images.

2. Description of the Related Art

In recent years, with the development of social media on the internet, there has been a large number of user generated content (UGC), such as micro-blog, WeChat, images, etc., which are issued by users on the internet.

When people express their views, they usually like to upload static images (such as photos) or motion images (such as video) so as to incorporate with text comments to explain their point of view. The text comment issued by the user usually contains plural sentences, and the relative images always contain plural images, while each sentence is corresponding to a different image or images. However, the arrangement of the text comment and of the images might not be aligned correctly. For example, a sentence arranged in the forefront of the text comment might be corresponding to an image arranged last in the order of the images shown, while a sentence arranged at the end of the text comment might be corresponding to an image arranged in the earlier in the order of the images shown.

Additionally, for some social sites, when a user uploads multiple images, the multiple images might be randomly arranged. As a result, the user might not be able to control the displaying order of the uploaded multiple images.

The problems mentioned above limit the application of UGC.

### SUMMARY

In view of the above problems, the present embodiments have an objective to provide a method, an apparatus and a non-transitory computer-readable storage medium for matching text to images.

According to sonic embodiments, a method for matching text to images comprises: acquiring a plurality of images and corresponding text comments that includes a plurality of segments: retrieving, based on a pre-established key-word library, a key word of each segment; and matching a segment, according to the key word retrieved from the segment, to a corresponding image selected from the plurality of images.

According to some other embodiments, an apparatus for matching text to images comprises: processing circuitry configured to acquire a plurality of images and a corresponding text comment that includes a plurality of segments: retrieve, based on a pre-established key-word library, key word of each segment; and match a segment, according to the key word retrieved from the segment, to a corresponding image(s) from the plurality of images.

According to still some other embodiments, a non-transitory computer-readable storage medium includes computer executable instructions, wherein the instructions, when executed by a computer, cause the computer to execute a process for matching text to images, the process comprising: acquiring a plurality of images and corresponding text comments that includes a plurality of segments: retrieving, based on a pre-established key-word library, key word of each segment; and matching a segment, according to the key word retrieved from the segment, to a corresponding image selected from the plural images.

According to the embodiments, each segment of the text comment might be correctly matched to the image or images. Furthermore, by retrieving key word of each segment and using the key word for labeling the images, quite small number of keywords is used for establish the relationship between the text and the image characterize, therefore the matching process is quite simplified with improved accuracy of matching result.

### BRIEF DESCRIPTION OF THE DRAWINGS

FIG. 1 is a flowchart illustrating a method for matching text to images according to an embodiment of the present invention;

FIG. 2 is a flowchart illustrating a method for matching text to images according to another embodiment of the present invention;

FIG. 3 is a flowchart illustrating the labeling step according to an embodiment of the present invention;

FIG. 4 is a flowchart illustrating a method for matching text to images according to still another embodiment of the present invention;

FIG. 5 is graph illustrating the labeling result according to an embodiment of the present invention;

FIG. 6 is a diagram illustrating the input text with images and the matched text with images according to an embodiment of the present invention;

FIG. 7 is a structure block diagram illustrating an apparatus for matching text to images according to an embodiment of the present invention;

FIG. 8 is a structure block diagram illustrating an apparatus for matching text to images according to another embodiment of the present invention; and

FIG. 9 is an overall hardware block diagram illustrating an device for matching text to images according to an embodiment of the present invention.

### DETAILED DESCRIPTION

In the following, embodiments are described in detail with reference to the accompanying drawings, so as to facilitate the understanding of the claimed invention. It should be noted that, in the specification and the drawings, the steps and the units that are essentially the same are represented by the same symbols, and the repetitive description of these steps and units will be omitted.

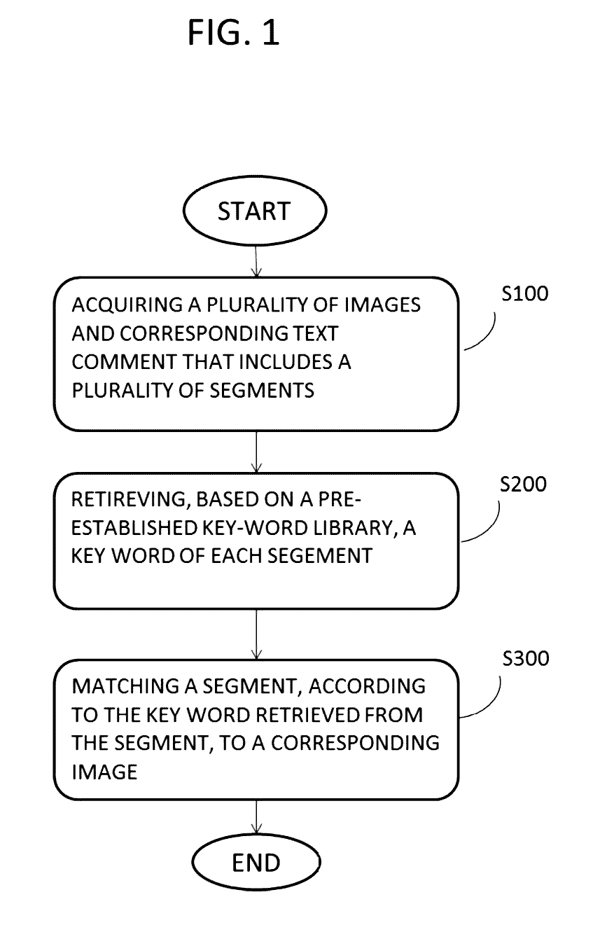

FIG. 1 is a flowchart illustrating a method for matching text to images according to an embodiment. In the following, the method for matching text to images according to the embodiment will be described with reference to FIG. 1.

As shown in FIG. 1, in step S100, a plurality of images and corresponding text comment that includes a plurality of segments were acquired. The text comment might be a comment described in natural language, such as a comment for a product that purchased by a user on the internet. According to an example, the text comment might be a comment for the function, appearance of a camera, and the images might be shot by the camera.

It should be noted that, in the following description, a comment for the function, appearance of a camera, and images shot by the cameral are described as an example. However, the claimed invention should not to be limited in this ease. For example, the text comment may be about some competitor products and the images are about the appearance of the products, or the text comment may be about some processes and the images are about the processing result by such processes, and so on.

Additionally, according to another example, in step S100, the text comment was segmented into several segments, for example, the text comment might be segmented by a comma, semi-colon, or period. It should be noted that, the text comment might be segmented by another unit, such as a paragraph, predetermined number of words, or any other unit.

Next, in step S200, a key word (or key words) (in the following description, “a key word” should be comprehended as a key word or key words) of each segment of the text comment was (were) retrieved based on a pre-established key-word library. According to an example, the key word in the pre-established key-word library might be obtained by acquiring an existing text comment, for example, a text comment on the social media, and retrieving the key word of the existing text comment. In addition, the key word in the pre-established key-word library might also be obtained by acquiring image tags uploaded by other user.

In particular, the key-word library might include a first candidate word retrieved from another text comment that is different from the text comment about the plurality of images; and a second candidate word retrieved from the tag of other image different within the plurality of images.

Optionally, the key word in the key-word library might be classified into several classifications, and each classification has a weight, and then in the matching step (S300, described in the following), the weighted number of the tags was calculated as the correlative-value.

According to an example, the first candidate word and the second candidate word contain a word belong to any classification/classifications selected from a group consisting of subject, scene, image metadata, positional relationship of the plurality of images, a high-frequency word (meaning a word with a frequency higher than a predetermined frequency appeared in the text comment), and so on.

For example, the classification “subject” might include “man”, “woman”, “child”, “student”, “flower”, “dog”, “cat”, “mountain”, and so on.

The classification “scene” might include “snow”, “fine weather”, “cloudy”, “indoors”, and so on.

The classification “image metadata” might be obtained from the corresponding EXIF information generated when shooting the image, and the “image metadata” might include “shooting time”, “place”, “model”, “the aperture size”, “shutter speed”, “ISO value”, and so on.

The classification “image characteristic” might include the description for the image feature such as “reddish”, “yellowish”, “purplish”, and so on.

The classification “positional relationship” of a plurality of images might be an expression for the arrangement of the images such as “the first”, “the second”, “the last one”, and so on.

Furthermore, the classification “high-frequency word” might be the word related to a problem frequently occurring in the images, such as “red eyes”, “closed eyes”, “blur”, “noise”, and so on.

Some words of the first candidate words might be the same with some words of the second candidate words. For example, the word expressing the subject might appear in the text as well as in the tag of the images. Optionally, according to another example, a merging process might be implemented for the first candidate word and the second candidate word in order to facilitate the subsequent operations. For example, in the merging process, the word of the first candidate words repeated in the second candidate word might be deleted, or only the words belong to the subject classification and scene classification might be stored and all other kinds of the key word might be deleted.

It should be noted that, the key word of each segment might be retrieved via a text analyzer. The text analyzer might retrieve a keyword through any existing technologies. For example, a high-frequency keyword about subjects or scenes in an image might be retrieved though statistical analysis. For example, in camera view websites, as high-frequency keywords, “noise reduction”, “portrait”, “red eye”, etc., could be retrieved though statistical analysis.

Next, in step S300, a segment was matched to a corresponding image based on the key word retrieved from the segment. For example, a segment could be matched to an image by identifying the image based on the key word retrieved from the segment, or identifying the image and getting the image characteristic and then comparing the image characteristic with the key word retrieved from the segment, or through any other image identifying method.

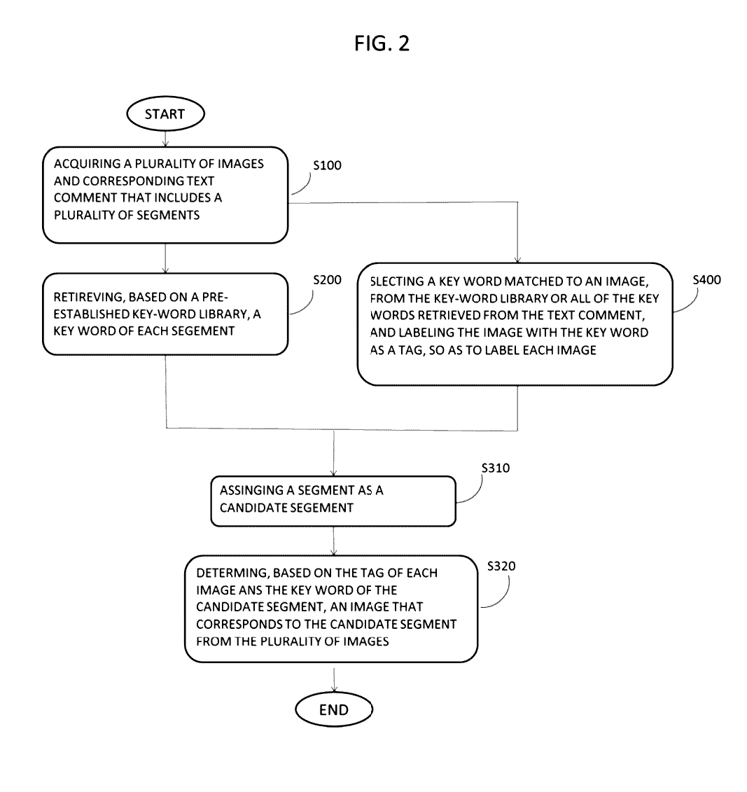

Furthermore, as shown in FIG. 2, step S300 might include step S310, and step S320. In details, in step S310, a segment was assigned as a candidate segment, and in step S320, whether an image is corresponded to the candidate segment is determined based on the tag of the image and the key word of the candidate segment.

According to an example, as shown in FIG. 2, in order to match text to images, the method further includes step S400. In step S400, each image was labeled with a tag or tags. In order to label the image, a key word which could match to the image was selected from the key-word library or all of the key words retrieved from the text comment, and the key word was used as a tag for labeling the image. It should be noted that, one image might be labeled with several tags. Furthermore, if selected from all of the key words retrieved from the text comment, the identifying process might be finished using less calculation time and the labeling process might be more efficiency.

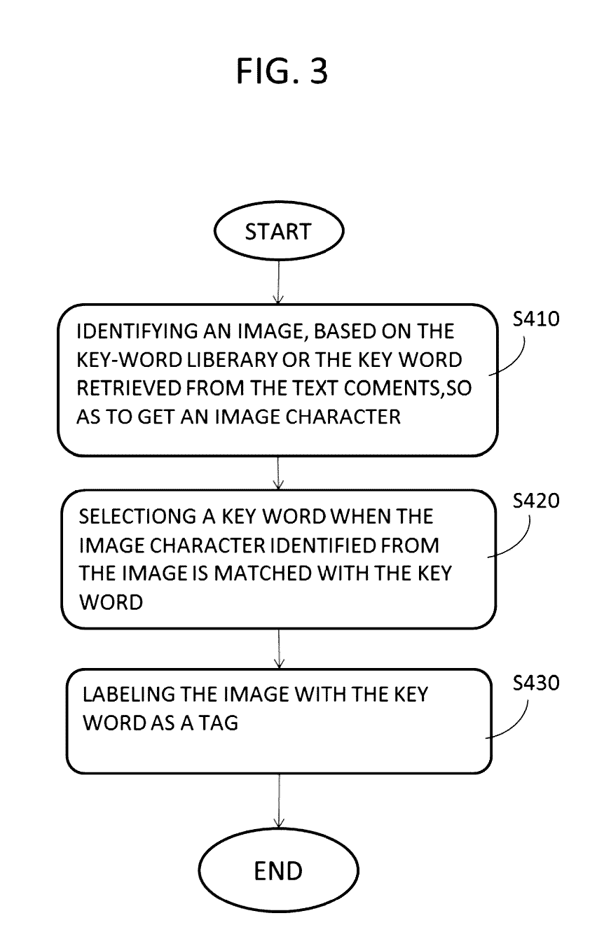

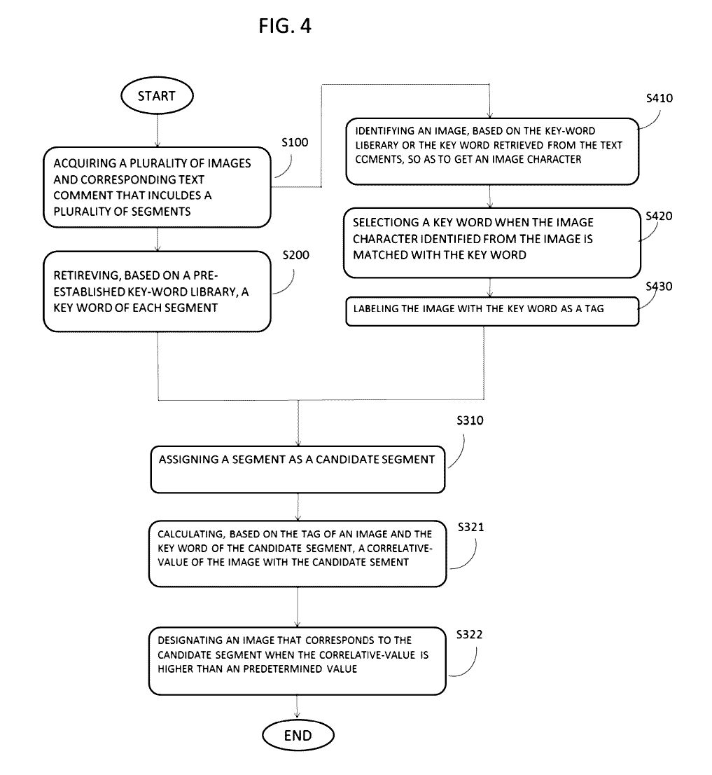

According to another example, as shown in FIG. 3 and FIG. 4, in order to label an image, the step S400 might further includes step S410, step S420, and step S430. In step S410, an image might be identified and an image character might be retrieved based on the key-word library or the key word retrieved from the text comments. In step S420, a key word was selected if the image character identified from the image is matched with the key word. In step S430, the image was labeled with the key word selected in step S420 as a tag. It should be noted that an image might have several tags.

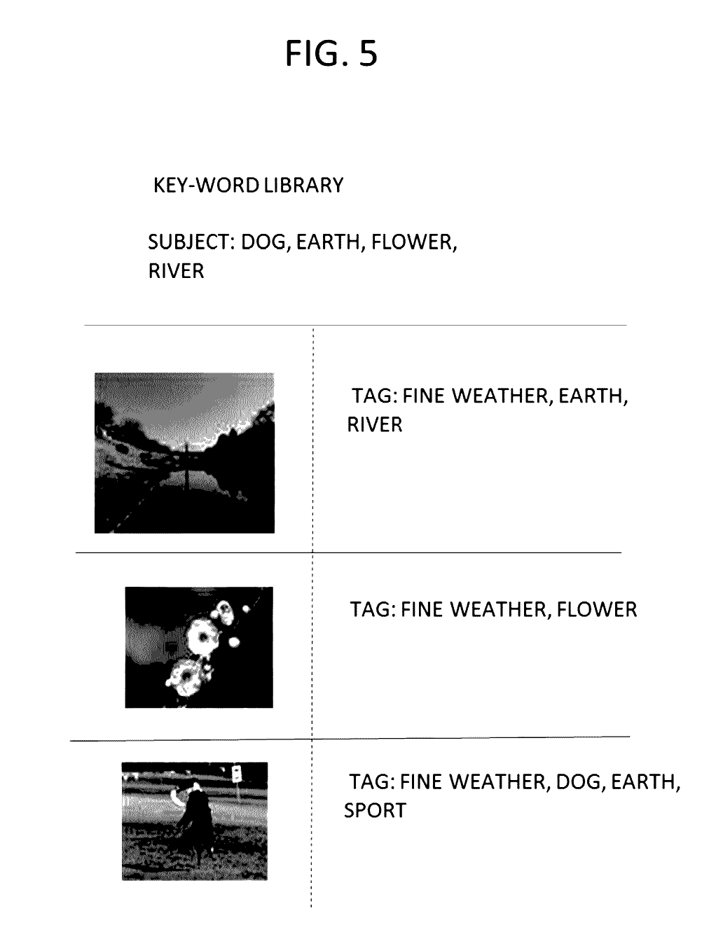

According to an example of the present invention, as shown in FIG. 5, the plurality of images includes an image showing a river, an image showing a flower, and an image showing a dog. As an example, the key-word library contains the classification of “subject” and “scene”, while the subject classification contains the key word such as “dog”, “earth”, “flower”, “river” and so on, and the scene classification contains the key word such as “fine weather”, “sport”, and so on. In step S410, the images were identified based on the key word “dog”, “earth”, “flower”, “river”, “line weather”, “sport” and so on, and as an identifying result, the top image was related to “fine weather”, “earth” and “river”, the middle image was related to “fine weather” and “flower” while the bottom image was relate to “dog”, “fine weather”, “sport”, and “earth”. Therefore, in step S420, for the top image, the words “fine weather”, “earth” and “river” were elected, for the middle image, the word “fine weather” and “flower” were elected, and for the bottom image, the word “dog”, “fine weather”, “sport”, and “earth” were elected. And then, in step S430, as a result, the top image were labeled three tags as “fine weather”, “earth”, and “river”, the middle image were labeled two tags as “fine weather” and “flower”, and the bottom image were labeled four tags as “dog”, “fine weather”, “sport”, and “earth”.

According to an example of the present invention, the key word retrieved from the text comment includes a classification of “position relationship”, such as a word “first”, “second”, “third”, “last” and so on, during the labeling step S400, the position relationship of the images was firstly identified and was labeled as a tag of the image. Therefore, during the matching step S300, the text comment might be easily matched to images based on the position relationship with quite a small volume of key words, and no other classification such as the subject classification and/or scene classification for getting the contents or characteristics of the image is needed.

It should be noted that, because the key-word library might have a higher number of key words retrieved from the text comments, in step S410, when the image was identified based on the key-word library, the identifying process might take more time than it was identified based on the key word retrieved from the text comments.

After all of the images were labeled, in step S320, as shown in FIG. 4, it might include step S321, and step S322. In step S321, a correlative-value of the image with the candidate segment was calculated based on the tag of an image and the key word of the candidate segment, and then, in step S322, if the correlative-value is higher than a predetermined value the image was designated as corresponding to the candidate segment.

It should be noted that, an image might be determined as the image matched to the candidate segment by another method. For example, when the tag was labeled based on the key word retrieved from the text comments and an image has the most number of the tags that were corresponding to the key word retrieved from the candidate segment, then the image might be determined as the matched image to the candidate segment.

Furthermore, in step S322, the number of the tags, which were the same with or which correspond to the key word of the candidate segment, was calculated as the correlative-value, and if the correlative-value is higher than a predetermined value the image was designated as corresponding to the candidate segment.

It should he noted that, each classification of the first candidate word and the second candidate word described above might have a predetermined weighting factor. And then, when calculating the correlative-value, a weighted number of the tags correlated to the candidate segment is calculated as the correlative-value of the image to the candidate segment.

After each segment was assigned as a candidate segment and the determination step was executed, the process matching text to the images ends. It should be noted that, a segment might be matched to several images, and also, an image might be matched to several segments. Therefore, after one segment was assigned as a candidate segment and the determination step was executed, in order to matching another segment to images, the determination step might be executed for all the images rather than the remaining images.

It should be noted that, steps of the method for matching text to images according to the embodiments need not to be executed orderly as shown in FIGS. 1 to 4, the steps might be executed in reversed or parallel. For example, assignment step might be executed firstly and then the retrieving step might be executed for the candidate sentence. Additionally, the tags generated according to the method shown in FIGS. 3 and 4 might be added into the key-word library as the second candidate word for determining the corresponding relationship between the other images and the text comments about such images.

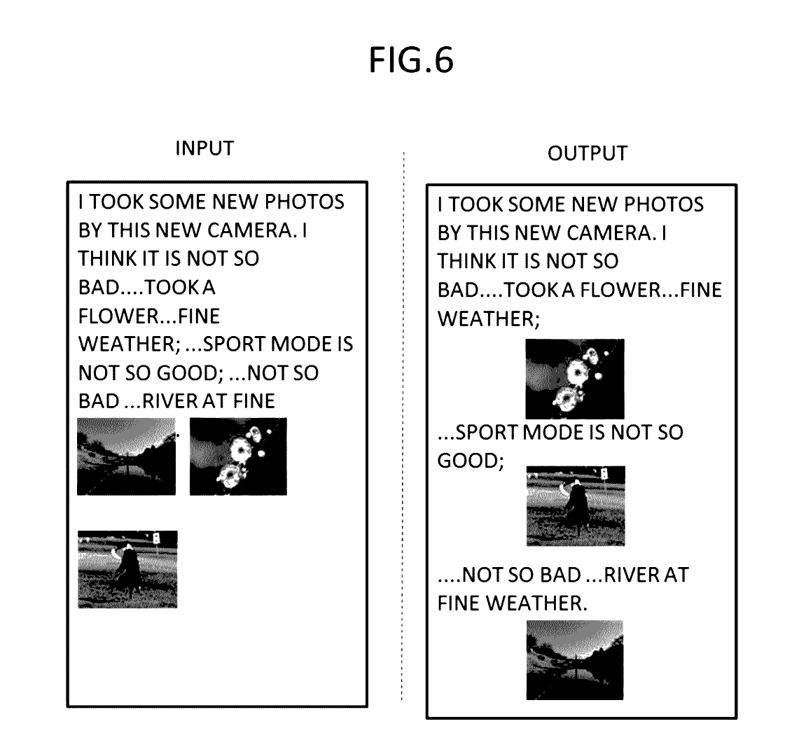

According to an example, as shown in FIG. 6, a text comment with 4 segments, includes segment 1 “I took some photos by this new camera”, segment 2 “I think it is not so bad . . . took a flower . . . fine weather;”, segment 3 “however, . . . the sport mode is not so good;” and segment 4 “but . . . not so bad . . . river at fine whether.” A plurality images, and 3 images were inputted. After matched via the method according to an example, each segment with matched images was outputted. It should be noted that, FIG. 6 is only an example, and the claimed invention should not be limited to this example.

It should be noted that FIG. 6 only shows an example. According to another example, a corresponding relationship might be provided as the output. The corresponding relationship might be described as the following formula:

connections={(sₘiₙ)|m=1,2,3, . . . ,M n=1,2,3, . . . , N}

Where, “connections” represents the corresponding relationship, sₘ represents a segment in the text comment, iₙ represents an image matched to the segment, the text has M pieces of segments, and there are a total of N images, where M, and N are independent integers. If there is no connection between sⱼ and iₖ, then (sⱼ, iₖ) will not be output.

As described above, according to the embodiments of a method for matching text to images, each segment of the text comment could be matched to corresponding images. Additionally, by retrieving the key word from the text comment and using the retrieved key words in the matching step, quite a small volume of key words is required in order to correspond to most image characteristics of the images. Therefore the matching process is simple with a high accuracy.

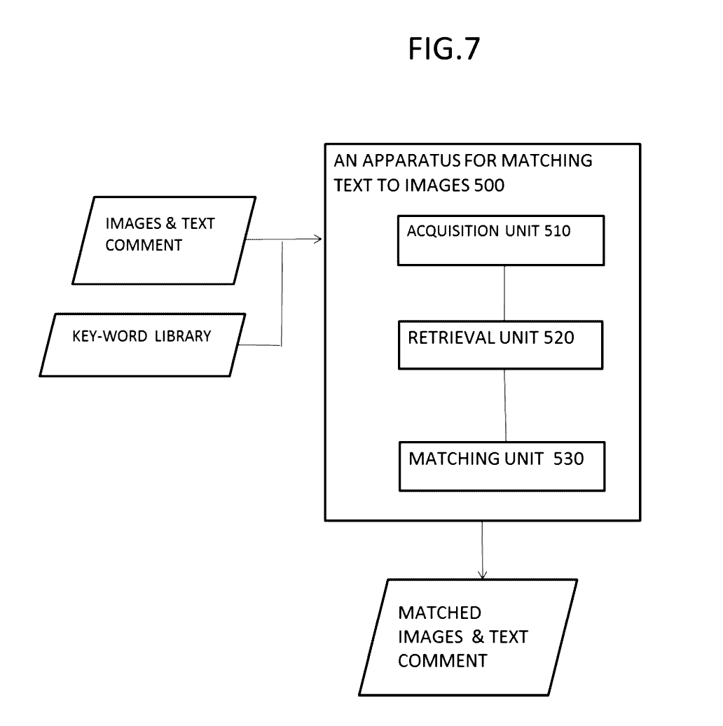

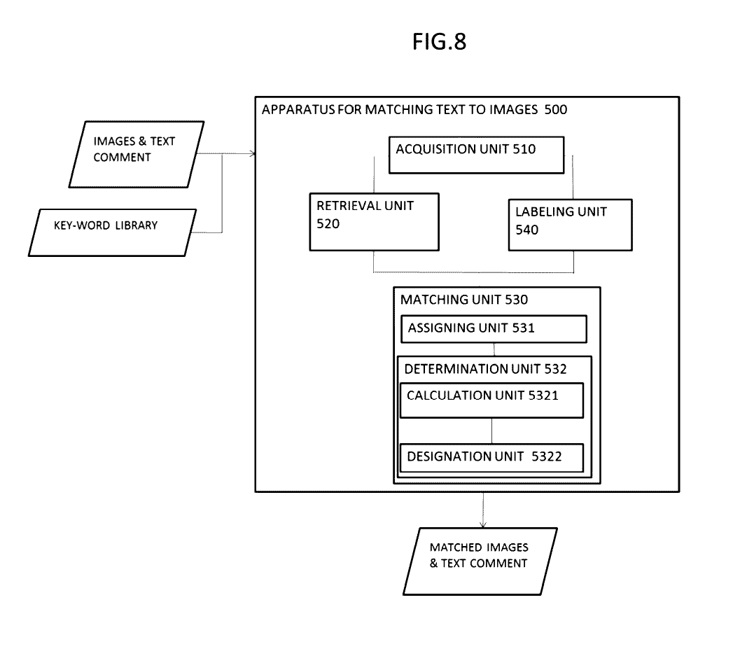

In the following, an apparatus for matching text to images according to an embodiment will be described with reference to FIG. 7 and FIG. 8.

FIG. 7 is a structure block diagram illustrating an apparatus for matching text to images according to an embodiment. FIG. 8 is a structure block diagram illustrating an apparatus for matching text to images according to another embodiment.

As shown in FIG. 7, an apparatus 500 for matching text to images according to an embodiment might include: acquisition unit 510, retrieval unit 520 and a matching unit 530. The units in the apparatus 500 for matching text to images may respectively execute the steps/functions in the method in FIG. I. Accordingly, only main units of the apparatus 500 will be described below, and the detailed descriptions that have been described above with reference to FIG. 1 will, be omitted.

Specifically_{:} the acquisition unit 510 acquires a plurality of images and a corresponding text comment that includes a plurality of segments. The text comment might be a comment described in natural language, such as a comment for a product, such as a camera, purchased by a user on the internet. According to an example, the text comment might be a comment for the function, appearance of a camera, and the images shot by the camera.

According to another example, the text comment might be segmented into several segments by the acquisition unit 510. For example, the text comment night be segmented by a comma, semi-colon, or period. It should be noted that, the text comment might be segmented by other unit, such as a paragraph, predetermined number of words, or any other unit.

And then, key word of each segment of the text comment was retrieved by retrieval unit 520 based on a pre-established key-word library. According to an example, the key word in the pre-established key-word library might be obtained by acquiring an existing text comment, for example, a text comment on the social media, and retrieving the key word of the existing text comment. In addition, the key word in the pre-established key-word library might also be obtained by acquiring image tags uploaded by another user. It should be noted that the pre-established key word library might be stored in the apparatus 500, and it might also be stored in a storage medium which is independent to but connected with the apparatus 500.

Matching unit 530 is a unit for matching a segment to a corresponding image based on the key word retrieved from the segment. For example, a segment could be matched to an image by identifying the image based on the key word retrieved from the segment, or identifying the image and getting the image characteristic and then comparing the image characteristic with the key word retrieved from the segment, or through any other image identifying method.

Furthermore, as shown in Fha8, matching unit 530 might include an assigning unit 531, and a determination unit 532. In details, the assigning unit 531 assigned a segment as a candidate segment, and determination unit 532 determined whether an image corresponds to the candidate segment based on the tag of the image and the key word of the candidate segment.

According to an example, as shown in FIG.8, the apparatus 500 might further include a labeling unit 540 for selecting a key word matched to an image, based on the key-word library or all of the key words retrieved from the text con tent, and labeling the image with the key word as a tag.

It should be noted that, because the key-word library might have higher number of key words retrieved from the text comments, when the image was identified based on the key-word library, the identifying process might cost more time than it was identified based on the key word retrieved from the text comments.

Additionally, as shown in F1G..8, the determination unit 532 might include calculation unit 5321 and designation unit 5322

Calculation unit 5321 calculates a correlative-value of the image with the candidate segment based on the tag of an image and the key word of the candidate segment, and designation unit 5322 designates an image corresponding to the candidate segment if the correlative-value is higher than a predetermined value.

It should be noted that, an image might be determined as the image matched to the t 3 candidate segment by another method. For example, when the tag, was labeled based on the key word retrieved from the text comments and an image has the most number of the tag that is the same as the key word retrieved from the candidate segment, then the image might be determined as the matched image to the candidate segment.

Furthermore, the number of the tags, which were the same with or correspond to the key word of the candidate segment, was calculated as the correlative-value, and if the correlative-value is higher than a predetermined value the image was designated as corresponding to the candidate segment.

As described above, according to the embodiment of the apparatus for matching text to images, each segment of the text comment could be matched to corresponded images. Additionally, by retrieving the key word from the text comment and using the retrieved key words in the matching step, quite a small volume of key words is required in order to correspond to most image characteristics of the images, therefore the matching process is simple with high accuracy.

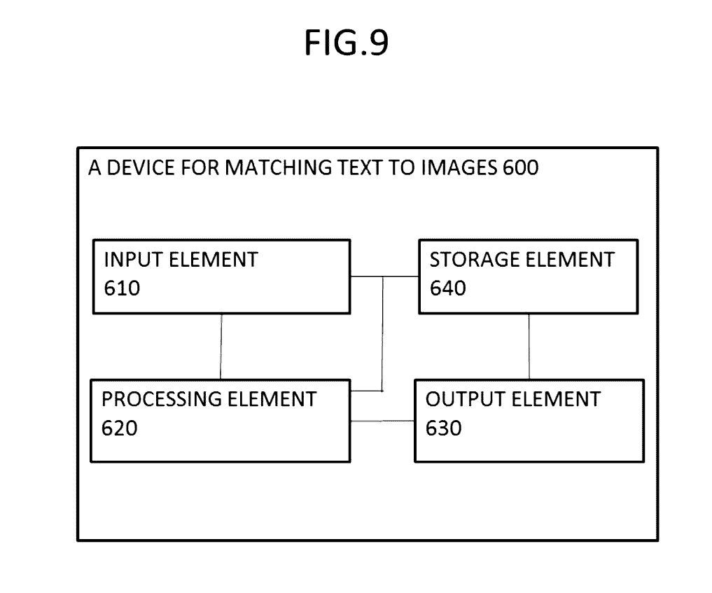

According to another embodiment, there may also be a device provided for detecting an abnormal situation. FIG, 9 is an overall hardware block diagram illustrating a device 680 for matching text to images according to an embodiment of the present invention. As illustrated in FIG. 9, the device 600 might include: an input element 610, for inputting images and relative images, which might be acquired from social media, including image transmission cables, image input ports, etc.; a processing element 620 for implementing the above method for matching text to images according to the embodiments, such as a CPU of a computer, processing circuitry, or other chips having. processing ability, etc., which are connected to a network such as the Internet (not shown) to transmit the processed results to the remote apparatus based on the demands of the t 4 processing; an output apparatus 630 for outputting the result obtained by implementing the above process of matching text to images to the outside, such as a screen, a communication network and a remote output device connected thereto, etc.; and a storage apparatus 640 for storing the data including relative images, text comments, pre-established key word library by a volatile method or a nonvolatile method, such as various kinds of volatile or nonvolatile memory including a random-access memory (RAM), a read-only memory (ROM), a hard disk and a semiconductor memory.

As known by a person skilled in the art, the present examples ma be implemented as a system, an apparatus, a method or a computer program product. Therefore, the present examples may be specifically implemented as hardware, software (including firmware, resident software, micro-code, etc.) or a combination of hardware and software, which is referred to as a “assembly”, “module”, “apparatus” or “system”. Additionally, the present examples may also be implemented as a computer program product in one or more computer-readable media, and the computer-readable media include computer-readable computer codes.

Any combinations of one or more computer-readable media may be used. The computer-readable medium may be a computer-readable signal medium or a computer-readable storage medium. The computer-readable storage medium may be, for example, as system, apparatus or an element of electric, magnetic, optic, electromagnetic, infrared or semiconductor, or a combination of any of the above, but is not limited to them. Specifically, the computer-readable storage medium may include a single electrical connection having a plurality of wires, a portable computer disk, a hard disk, a random access memory (RAM), a read-only memory (ROM), an erasable programmable read-only memory (an EPROM or a Flash memory), an optical fiber, a portable compact disc read-only memory (CD-ROM), an optical memory device, a magnetic storage device, or a suitable combination of any of the above. In the present specification, the computer-readable storage medium may include a tangible medium including or storing a program, and the program may be used by an instruction execution system, apparatus, device or a combination thereof.

The computer-readable signal medium may include data signals to be propagated as a part of a carrier wave, where computer-readable program codes are loaded. The propagated data signals may be electromagnetic signals, optical signals or a suitable combination thereof, but is not limited to these signals. The computer-readable medium may also be any non-transitory computer-readable medium including the computer-readable storage medium. The computer-readable medium may send, propagate or transmit a program used by an instruction execution system, apparatus, device or a combination thereof.

The present examples are described with reference to the flowcharts and/or block diagrams of the method, apparatus (system) and computer program products according to the embodiments of the present invention. It should be noted that, each block and a combination of the blocks in the flowcharts and/or the block diagrams may be implemented by computer program instructions. The computer program instructions may be provided to a processor of a general-purpose computer, a special purpose computer or other programmable data processing apparatus, and the computer program instructions are executed by the computer or other programmable data processing apparatus to implement functions/operations in the flowcharts and/or the block diagrams.

The computer program instructions may also be stored in the computer-readable medium for making the computer or other programmable data processing apparatus operate in a specific manner, and the instructions stored in the computer-readable medium may generate manufactures of an instruction means for implementing the functions/operations in the flowcharts and/or the block diagrams.

The computer program instructions may also be loaded on the computer, other programmable data processing apparatus or other device, so as to execute a series of operation steps in the computer, other programmable data processing apparatus or other device, so that the instructions executed in the computer or other programmable apparatus can provide a process for implementing the functions/operations in the flowcharts and/or block diagrams.

The available system structure, functions and operations of the system, method and computer program product according to the present invention are illustrated by the flowcharts and block diagrams in the drawings. Each of the blocks in the flowcharts or block diagrams represent a module, program segment or a part of codes, and the module, program segment or the part of codes include one or more executable instructions for implementing logic functions. It should be noted that, in the apparatus or method of the present invention, units or steps may be divided and/or recombined. It should be noted that, block diagrams and/or blocks in flowcharts, and the combinations of block diagrams and/or blocks in flowcharts may be implemented using a system based on dedicated hardware for performing specific functions or operations, or may be implemented using a combination of dedicated hardware and computer commands.

The claimed invention is not limited to the specifically disclosed embodiments, and various modifications, combinations and replacements may be made without departing from the scope of the present invention.

What is claimed is:

1. A method for matching text to images, comprising:
acquiring a plurality of images and corresponding text comments that includes a plurality of segments;
retrieving, based on a pre-established key-word library, a key word of each segment; and
matching a segment, based on the key word retrieved from the segment, to a corresponding image selected from the plurality of images.

2. The method according to claim 1, wherein the method further comprises:
selecting a key word matched to an image, from the key-word library or all of the key words retrieved from the text comment, and labeling the image with the key word as a tag, so as to label each image,
and the matching includes:
assigning a segment as a candidate segment; and
determining, based on the tag of each image and the key word of the candidate segment, an image that corresponds to the candidate segment from the plurality of images.

3. The method according to claim 2, wherein the labeling includes:
identifying an image, based on the key-word library or the key word retrieved from the text comments, so as to get an image character,
selecting a key word when the image character identified from the image is matched with the key word, and
labeling the image with the key word as a tag.

4. The method according to claim 3, wherein the determining includes:
calculating, based on the tag of an image and the key word of the candidate segment, a correlative-value of the image with the candidate segment; and
designating an image corresponded to the candidate segment if the correlative-value is higher than an predetermined value.

5. The method according to claim 4, wherein the key-word library includes:
a first candidate word retrieved from another text comment that is different from the text comment about the plurality of images; and
a second candidate word retrieved from the tag of other image different with the plurality of images.

6. The method according to claim 5, wherein the first candidate word and the second candidate word contain a word belong to a classification selected from a group including a subject, scene, image metadata, positional relationship between the plurality of images, and a high-frequency word.

7. The method according to claim 6, wherein each classification has a predetermined weighting factor, and a weighted number of the tags correlated to the candidate segment is calculated as the correlative-value of the image to the candidate segment.

8. The method according to one of claim 1, wherein the acquiring includes:
obtaining the text comment and segmenting the text comment into the plurality of segments by comma, semi-colon, full-stop, or paragraph.

9. An apparatus for matching text to images, comprising:
processing circuitry configured to
acquire a plurality of images and a corresponding text comment that includes a plurality of segments;
retrieve, based on a pre-established key-word library, key word of each segment; and
match a segment, according to the key word retrieved from the segment, to a corresponding image(s) from the plurality of images.

10. The apparatus according to claim 9, wherein the processing circuitry is configured to:
select a key word matched to an image, based on the key-word library or all of the key words retrieved from the text comment, and label the image with the key word as a tag,
assign a segment as a candidate segment; and
determine, based on the tag of each image and the key word of the candidate segment, an image that corresponds to the candidate segment from the plurality of images.

11. The apparatus according to claim 10, wherein the processing circuitry is configured to identify an image, based on the key-word library or the key word retrieved from the text comments, to get image character,
select a key word when the image character identified from the image is matched with the key word,
and label the image with the key word as a tag.

12. The apparatus according to claim 10, wherein the processing circuitry is configured to:
calculate, based on the tag of an image and the key word of the candidate segment, a correlative-value of the image with the candidate segment; and
designate an image corresponded to the candidate segment when the correlative-value is higher than an predetermined value.

13. The apparatus according to claim 12, wherein the key-word library includes:
a first candidate word retrieved from another text comment that is different from the text comment about the plurality of images; and
a second candidate word retrieved from the tag of other image different with the plurality of images.

14. The apparatus according to claim 13, wherein the first candidate word and the second candidate word contain a word selected from a group consist of subject, scene, image metadata, positional relation between the plurality of images, a word with a frequency higher than a predetermined frequency of the text comment.

15. The apparatus according to claim 14, wherein each classification has a predetermined weight and a weighted number of the tags correlated to the candidate segment is calculated as the correlative-value of the image to the candidate segment.

16. The apparatus according to claim 9, wherein the processing circuitry is configured to obtain the text comment and segment the text comment into the plurality of segments by comma, semi-colon, period, or paragraph.

17. A non-transitory computer-readable storage medium including computer executable instructions, wherein the instructions, when executed by a computer, cause the computer to execute a process for matching text to images, the process comprising:
acquiring a plurality of images and corresponding text comments that includes a plurality of segments;
retrieving, based on a pre-established key-word library, a key word of each segment; and
matching a segment, according to the key word retrieved from the segment, to a corresponding image(s) from the plural images.
